(19) United States
(12) Patent Application Publication
(10) Pub. No.: US 2014/0067493 A1
(43) Pub. Date: Mar. 6, 2014

(54) SYSTEM FOR COMBINING PAYMENT FOR ELECTRIC VEHICLE CHARGING AND PARKING

(71) Applicant: Optimization Technologies, Inc., Portland, OR (US)

(72) Inventor: Dexter Turner, West Linn, OR (US)

(73) Assignee: Optimization Technologies, Inc., Portland, OR (US)

(21) Appl. No.: 14/065,200

(22) Filed: Oct. 28, 2013

Related U.S. Application Data
(63) Continuation-in-part of application No. 14/047,842, filed on Oct. 7, 2013.
Application No. 14/047,842 is a continuation-in-part of application No. 14/014,108, filed on Aug. 29, 2013.
(60) Provisional application No. 61/719,483, filed on Oct. 28, 2012.
(60) Provisional application No. 61/710,643, filed on Oct. 5, 2012.
(60) Provisional application No. 61/694,647, filed on Aug. 29, 2012.

(51) Int. Cl. G07B 15/06

(52) U.S. Cl. CPC G07B 15/06
USPC 705/13

(57) ABSTRACT

Disclosed herein are representative embodiments of methods, apparatus, and systems relating to a system to use electric vehicle charging stations (“EVCSs”) and electric vehicle supply equipment (“EVSE”). Certain embodiments relate to methods, apparatus, and systems to combine the payment of both vehicle parking and the charging of electric vehicles into a single transaction.

### CROSS-REFERENCE TO RELATED APPLICATIONS

This application claims the benefit of U.S. Provisional Application No. 61/719,483 filed on Oct. 28, 2012, and entitled “SYSTEM FOR COMBINING PAYMENT FOR ELECTRIC VEHICLE CHARGING AND PARKING” which is hereby incorporated herein by reference.

This application is also a continuation-in-part of U.S. Nonprovisional application Ser. No. 14/047,842 filed on Oct. 5, 2013, and entitled “SYSTEM FOR PARKING PAYMENT USING A MOBILE DEVICE,” which claims the benefit of U.S. Provisional Application No. 61/710,643 filed on Oct. 5, 2012, and entitled “SYSTEM FOR PARKING PAYMENT USING A MOBILE DEVICE,” and which is also a continuation-in-part of U.S. Nonprovisional application Ser. No. 14/014,108, filed on Aug. 29, 2013 and entitled “ELECTRIC VEHICLE CHARGING STATION MOBILE DEVICE PAYMENT SYSTEM”, which claims the benefit of U.S. Provisional Application No. 61/694,647, filed on Aug. 29, 2012, and entitled “ELECTRIC VEHICLE CHARGING STATION MOBILE DEVICE PAYMENT SYSTEM”, all of which hereby incorporated herein by reference.

### FIELD

This application relates to electric vehicle charging stations and associated systems.

### SUMMARY

Disclosed below are representative embodiments of methods, apparatus, and systems relating to a system to use electric vehicle charging stations (“EVCSs”) and electric vehicle supply equipment (“EVSE”) for the payment of both vehicle parking and the charging of electric vehicles. The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, any features or aspects of the disclosed embodiments can be used in various combinations and subcombinations with one another.

Among the embodiments disclosed herein are electric vehicle charging station systems that control access to and payment for the use of the charging stations as well as payment for parking. Embodiments of the disclosed technology can be used to improve the basic process of charging an electric vehicle by eliminating the need to pay for parking separately from paying for charging the vehicle. Among the disclosed embodiments is an access control and payment system that uses a customer's parking ticket or stub to link a parking and charging session.

One exemplary embodiment is a method comprises scanning, reading, or entering a parking stub's or ticket's unique parking session identifier at a touchscreen display apparatus or other input device of an electric vehicle charging station (“EVCS”) or electric vehicle supply equipment (“EVSE”) and affiliating the parking session identifier with a unique identifier of a charging session. Another exemplary embodiment comprises inputting, scanning, reading, or otherwise entering a parking stub's or ticket's unique parking session identifier with a mobile payment application running on an Internet-connected mobile device and affiliating the parking session identifier with a unique identifier of a charging session. A related embodiment comprises one or more non-transitory computer-readable media storing computer-executable instructions which when executed by a computer cause the computer to perform the method.

Another exemplary embodiment is a computer-implemented method comprising receiving a parking stub's or ticket's unique parking session identifier from an input device at an electric vehicle charging station (“EVCS”) or electric vehicle supply equipment (“EVSE”) and affiliating this parking session identifier with a unique identifier of a charging session. A related embodiment comprises one or more non-transitory computer-readable media storing computer-executable instructions which when executed by a computer cause the computer to perform the method.

Another exemplary embodiment is a computer-implemented method comprising receiving data from an EVCS/EVSE or an Internet-connected mobile device, the data identifying a user at the EVCS or EVSE, identifying a unique charging session at the EVCS or EVSE, and also identifying a unique parking session; accessing account data associated with the user and control policies and pricing data associated with the EVCS/EVSE and/or the parking facility; using a combination of this data to determine if the user is authorized to complete a charging session at the EVCS/EVSE; and processing payment for both the use of the EVSE/EVSE and parking at the parking facility in a single transaction. A related embodiment comprises one or more non-transitory computer-readable media storing computer-executable instructions which when executed by a computer cause the computer to perform the method.

Embodiments of the disclosed systems and methods can be implemented using computing hardware, such as a computer processor embedded in the EVCS/EVSE and a parking payment kiosk (“PPK”) that dispenses parking tickets or stubs when a user enters a parking facility. Embodiments of the disclosed methods can be performed using software stored on one or more non-transitory computer-readable media (e.g., one or more optical media discs, volatile memory components (such as DRAM or SRAM), or nonvolatile memory or storage components (such as hard drives)). Such software can be executed by a computer processor embedded in the EVCS/EVSE or by one or more computers coupled to the EVCS/EVSE by a network (e.g., via the Internet, a wide-area network, a local-area network, a client-server network, or other such network). Embodiments of the disclosed methods can also be performed by specialized computing hardware (e.g., one or more application specific integrated circuits (“ASICs”) or programmable logic devices (such as field programmable gate arrays (“FPGAs”)) configured to perform any of the disclosed methods). Additionally, any intermediate or final result created or modified using any of the disclosed methods can be stored on a non-transitory storage medium (e.g., one or more optical media discs, volatile memory or storage components (such as DRAM or SRAM), or nonvolatile memory or storage components (such as hard drives or solid state drives)). Furthermore, any of the software embodiments (comprising, for example, computer-executable instructions which when executed by a computer cause the computer to perform any of the disclosed methods) or results (either intermediate or final) created or modified by the disclosed methods can be transmitted, received, or accessed through a suitable communication means.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic block diagram illustrating an exemplary electric vehicle charging system with a display device coupled to a back office serve via a network.

FIG. 2 is a schematic block diagram illustrating an exemplary EVCS/EVSE system integrated with a parking payment kiosk and the users of the exemplary system.

FIG. 3 is a flowchart of an exemplary method for using an EVCS/EVSE to pay for parking in addition to electrical charging according to an embodiment of the disclosed technology.

FIG. 4 illustrates an exemplary EVCS/EVSE screen showing a possible user interface instructing the user to scan/read the identifier from their parking ticket/stub.

FIG. 5 is a schematic block diagram of an exemplary computing environment for implementing embodiments of the disclosed technology.

### DETAILED DESCRIPTION

### I. General Considerations

Disclosed below are representative embodiments of methods, apparatus, and systems for using and operating electric vehicle charging stations (“EVCSs”) or electric vehicle supply equipment (“EVSE”) with mobile device payment technology. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “monitor” to describe the disclosed methods. These terms are high-level abstractions of the actual operations that are performed. The actual operations that correspond to these terms may vary depending on the particular implementation and are readily discernible by one of ordinary skill in the art. Furthermore, as used herein, the term “and/or” means any one item or combination of items in the phrase.

Any of the disclosed methods can be implemented using computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives)) and executed on a computer (e.g., any commercially available computer or a computer processor embedded in the EVCS/EVSE). Any of the intermediate or final data created and used during implementation of the disclosed methods or systems can also be stored on one or more computer-readable media (e.g., non-transitory computer-readable media).

For clarity, only certain selected aspects of the software-based embodiments are described. Other details that are well known in the art are omitted. For example, it should be understood that the software-based embodiments are not limited to any specific computer language or program. For instance, embodiments of the disclosed technology can be implemented by software written in C++, C#, Objective C, Java, Perl, JavaScript, Adobe Flash, or any other suitable programming language. Likewise, embodiments of the disclosed technology are not limited to any particular computer or type of hardware. Details of suitable computers and hardware are well known and need not be set forth in detail in this disclosure.

Furthermore, any of the software-based embodiments (comprising, for example, computer-executable instructions stored on a non-transitory computer-readable medium) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

The disclosed methods can also be implemented using specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)) specially designed to implement any of the disclosed methods. The integrated circuit or specialized computing hardware can be embedded in or directly coupled to an EVCS/EVSE or device that is configured to interact with the EVCS/EVSE.

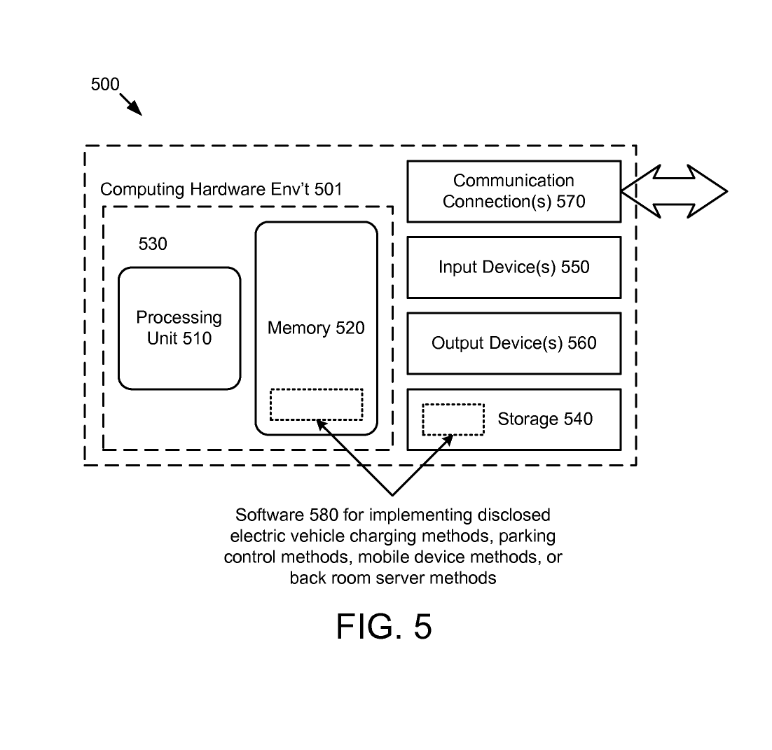

FIG. 5 is a schematic block diagram 500 that illustrates a generalized example of a suitable computing hardware environment 501 in which embodiments of the disclosed technology can be implemented. The computing hardware environment 501 is not intended to suggest any limitation as to the scope of use or functionality of the disclosed technology, as the technology can be implemented in diverse general-purpose or special-purpose computing environments.

With reference to FIG. 5, the computing hardware environment 501 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM, DRAM, SRAM), non-volatile memory (e.g., ROM, EEPROM, flash memory), or some combination of the two. The memory 520 can store software 580 for implementing one or more of the described techniques for operating or using the disclosed electric vehicle charging systems. For example, the memory 520 can store software 580 for implementing any of the disclosed methods and their accompanying user interfaces.

The computing hardware environment can have additional features. For example, the computing hardware environment 501 includes storage 540, one or more input devices 550, one or more output devices 560, and one or more communication connections 570. An interconnection mechanism (not shown) such as a bus, controller, or network interconnects the components of the computing hardware environment 501. Typically, operating system software (not shown) provides an operating environment for other software executing in the computing hardware environment 501, and coordinates activities of the components of the computing hardware environment 501.

Storage 540 is a type non-volatile memory and can be removable or non-removable. The storage 540 includes, for instance, magnetic disks (e.g., hard drives), magnetic tapes or cassettes, optical storage media (e.g., CD-ROMs or DVDs), or any other tangible non-transitory storage medium which can be used to store information and which can be accessed within or by the computing hardware environment 501. The storage 540 can store the software 580 for implementing any of the described techniques, systems, or environments.

The input device(s) 550 can be a touch input device such as a keyboard, mouse, touch screen, pen, trackball, a voice input device, a scanning device, or another device that provides input to the computing environment 501. The output device(s) 560 can be a display, touch screen, printer, speaker, or another device that provides output from the computing environment 501.

The communication connection(s) 570 enable communication over a communication medium to another computing entity. The communication medium conveys information such as computer-executable instructions, any of the intermediate or final messages or data used in implementing embodiments of the disclosed technology, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. For example, the communication connection(s) 570 can communicate with another computing entity over a wired or wireless network (e.g., the Internet, a wide-area network, a local-area network, a Wi-Fi network, a client-server network, a wireless mesh network, or other such network or any combination thereof).

Many of the methods, systems, and interfaces disclosed herein can be described in the general context of computer-executable instructions stored on one or more computer-readable media. Computer-readable media are any available media that can be accessed within or by a computing environment. By way of example, and not limitation, with the computing hardware environment 501, computer-readable media include tangible non-transitory computer-readable media such as memory 520 and storage 540 and do not encompass transitory carrier waves or signals. The various methods, systems, and interfaces disclosed herein can also be described in the general context of computer-executable instructions, such as those included in program modules, being executed in a computing environment on a target real or virtual processor. Generally, program modules include routines, programs, libraries, objects, classes, components, data structures, and the like that perform particular tasks or implement particular abstract data types. The functionality of the program modules may be combined or split between program modules as desired in various embodiments. Computer-executable instructions for program modules may be executed within a local or distributed computing environment.

### II. Exemplary Embodiments of the Disclosed Technology

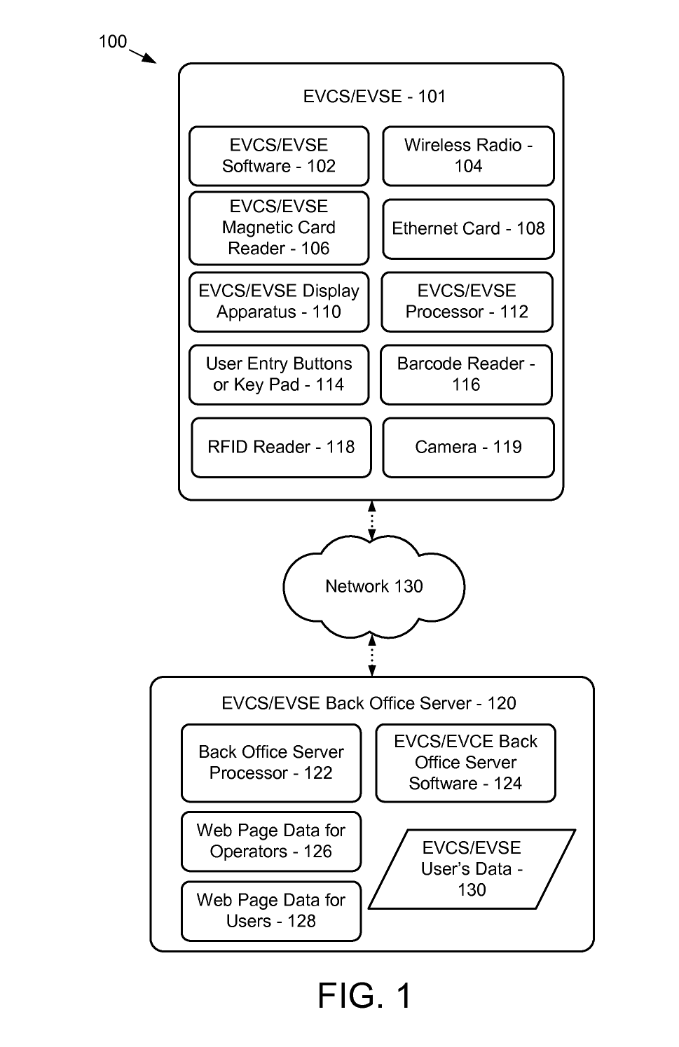

FIG. 1 is a schematic block diagram 100 illustrating an EVCS/EVSE computing hardware environment 101 for implementing embodiments of the disclosed technology. In particular, FIG. 1 illustrates an exemplary computing hardware environment 101 for an EVCS/EVSE and an exemplary computing hardware environment 120 for an EVCS/EVSE back office server. The EVCS/EVSE environment 101 is more specialized than computing hardware environment 501 but should not be construed as limiting the types of hardware that can be used to implement the disclosed technology. Furthermore, the EVCS/EVSE environment 101 and the exemplary computing hardware environment 120 for the EVCS/EVSE back office server can include any of the components described above with respect to the general computing hardware environment 501.

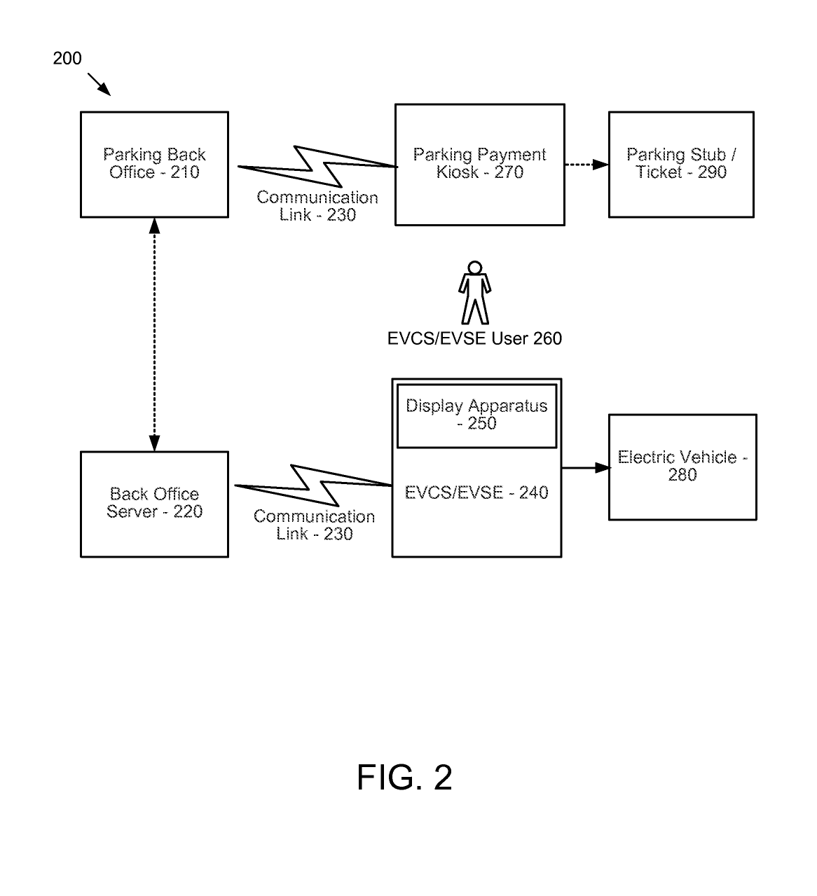

The EVCS/EVSE computing hardware environment 101 includes software 102, which comprises computer-executable instructions stored on non-transitory computer-readable media (e.g., any one or more of the non-transitory computer-readable media described above). When executed, the software can be used to implement the functionality of the EVCS/EVSE, which is described in more detail below. The EVCS/EVSE computing hardware environment 101 further comprises an EVCS/EVSE processor 112 for executing the software 102. Suitable processors and associated parts can be obtained, for example, from Parvus Corporation. In the illustrated embodiment, the EVCS/EVSE processor 112 is interconnected to an electric current control board 116. The electric current control board 116, in turn, is connected to the cables and electrical connectors of the EVCS/EVSE that provide the electrical coupling to the one or more electric vehicles (e.g., using a SAE J1772™ electrical connector, IEC 62196 electrical connector, or other such electric vehicle connector). Suitable electric current control boards and associated parts can be obtained, for example, from Texas Instruments, Riley Corp, and National Control Devices. In certain exemplary embodiments, the EVCS/EVSE software 102 is used to implement a process in which commands and data are exchanged to control the flow of electrical current to one or more electric vehicles plugged into the EVCS/EVSE (e.g., the EVCS/EVSE 240 shown in FIG. 2) and the payment for the delivery of this electrical current. The EVCS/EVSE computing hardware environment 101 can also include one or more of a wireless radio 104 (such as a cellular radio or Wi-Fi radio), and/or an Ethernet card 108 (or other network adapter) to provide the environment 101 with a wired and wireless interface capabilities for exchanging data with, for example, an EVCS/EVSE back office server 120. Suitable wireless radios and associated parts can be obtained, for example, from Digi International. Suitable cellular radios and associated parts can be obtained, for example, from Telit Communications Plc. The EVCS/EVSE computing hardware environment 101 also includes a magnetic card reader 106, and a display apparatus 110, such as an LCD or LED. The display device can be a touch screen display. Another possible option to facilitate user interaction is using a display device combined with a set of user entry buttons or a keypad 114. Suitable magnetic card readers and associated parts can be obtained, for example, from ID Tech. Suitable display devices and touch screen interfaces can be obtained, for example, from Logic Supply. Another possible option to facilitate interaction with the user is through a barcode reader 116. The barcode reader can be used to read or scan a barcode (e.g., a linear barcode, two-dimensional barcode quick reference (“QR”) code, or other such code) or alpha-numeric code that is printed on a parking ticket or stub. The barcode or other identifier that is printed on a parking ticket or stub can also be read using a camera 119 or other suitable image sensor. Still further, in certain embodiments, a radio frequency identification reader (“RFID”) can be included with the EVCS/EVSE for use in identifying users.

As more fully described below, the display apparatus 110 can be used to facilitate the charging of the electric vehicle and the proper billing (or crediting) for the electricity used by (or supplied to) the electric vehicle coupled to the EVCS/EVSE. As shown in FIG. 1, the EVCS/EVSE computing hardware environment 101 is coupled to the EVCS/EVSE back office server environment 120 via the network 130 (e.g., the Internet, a wide-area network, a local-area network, a Wi-Fi network, a client-server network, a wireless mesh network, or other such network or any combination thereof). In particular embodiments, the back office server environment 120 is implemented as part of a cloud-based back office server.

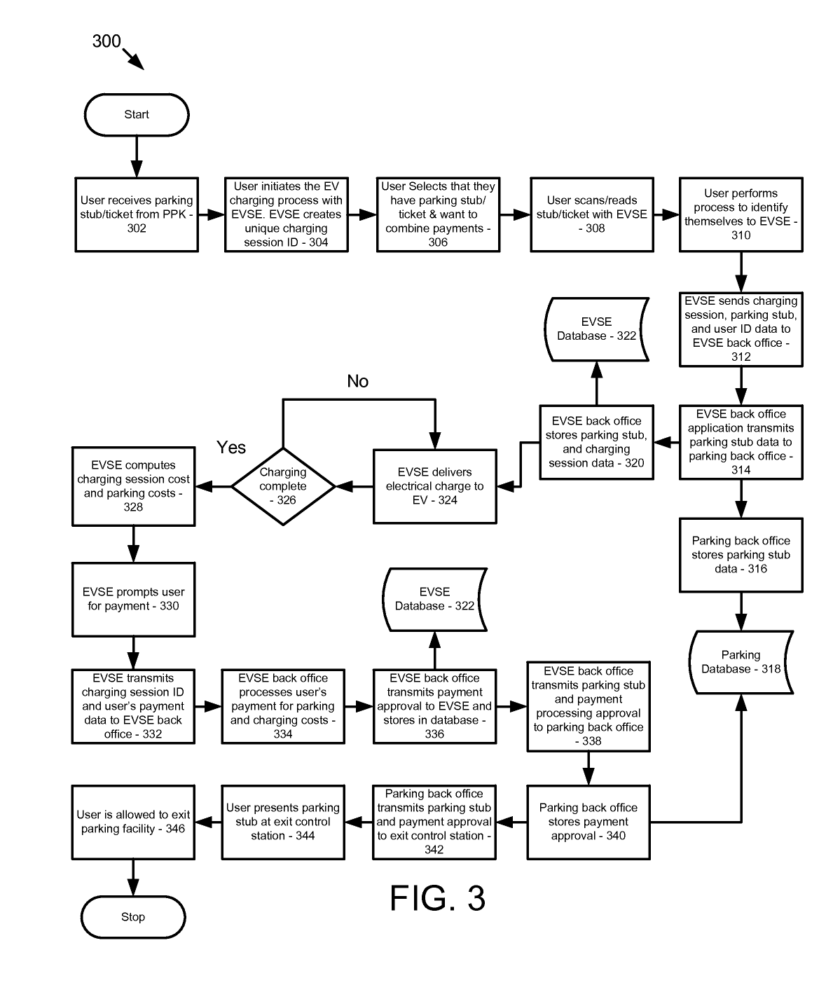

In operation, the EVCS/EVSE computing hardware environment 100 can create a number of data packets or messages that are transmitted to the EVCS/EVSE back office server environment 102 via a network 130. The EVCS/EVSE back office server environment 102 can receive these packets or messages and can also create data packets or messages that will be transmitted to the EVCS/EVSE computing hardware environment 100 via the network 130. An exemplary method and system for communicating between the EVCS/EVSE computing hardware environment 100 and the back office server environment 120 is described below in connection with FIG. 3.

Returning to FIG. 1, the back office server environment 120 can be implemented using a wide variety of computers and/or servers (e.g., a suitable commercially available server). In FIG. 1, the back office server environment 120 includes back office server software 124, which can comprise computer-executable instructions stored on non-transitory computer-readable media (e.g., any one or more of the non-transitory computer-readable media described above). When executed, the software can be used to implement the functionality of the back office server, which is described in more detail below. The EVCS/EVSE back office server 120 further comprises a back office server processor 122 for executing software 124. Also shown in FIG. 1 is EVSC/EVSE user data 130. The EVSC/EVSE user data 130 can comprise data stored on non-transitory computer-readable media that is related to users of the EVCS/EVSE. For example, the data can include data about a user's identification, address, account credit balance, usage history, vehicle, and/or other such user data.

In the illustrated embodiment, the EVCS/EVSE back office server 120 also includes data 126 for implementing one or more web pages for an EVCS/EVSE operator. The web page data 126 can comprise data stored on non-transitory computer-readable media that is used to render or otherwise implement one or more web pages for display to an EVCS/EVSE operator. The web pages can be displayed, for example, using a suitable Internet browser or media player implemented at a computer operated by the EVCS/EVSE operator and coupled to the back office server 120 via a network (e.g., the Internet, a wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the EVCS/EVSE operator is not stored as web page data, but as data usable via a non-web-based user interface (e.g., a dedicated program that directly interfaces with the back office server 120).

The EVCS/EVSE back office server 120 can also include data 128 for implementing one or more web pages for an EVCS/EVSE user. The web page data 128 can comprise data stored on non-transitory computer-readable media that is used to render or otherwise implement one or more web pages for display to an EVCS/EVSE user. The web pages can be displayed, for example, using a suitable Internet browser or media player implemented at a computer operated by the EVCS/EVSE user and coupled to the back office server 120 via a network (e.g., the Internet, a wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the EVCS/EVSE user is not stored as web page data, but as data usable via a non-web-based user interface (e.g., a dedicated program that directly interfaces with the back office server 120). In certain embodiments, the web page data 128 is data for implementing web pages that show the user information about the state of the user's account, including amount of credit balance and purchase history. For example, the web page data can include data for implementing a log-in screen, through which the user can provide authentication information indicating that the user is a member of a group authorized to use an EVCS/EVSE in a network of EVCSs/EVSE controlled by the back EVCS/EVSE back office server 120, and a data for implementing an account status screen, through which the user is presented a graphical or numerical indication of the state of the user's account. The EVCS/EVCE back office server software 124 can include code that receives information about the identity of the user at the log-in screen, matches the identity to an EVCS user database and causes the display of the information about the state of the user's account via one or more web pages displayed to the user. The information about the user's account can comprise, for instance, the current credit balance in the account, the method of payment (e.g., credit/debit card or bank account information) to be used for electric charging payment purposes, and a record of past charges against this account.

FIG. 2 is a schematic block diagram 200 illustrating an exemplary EVCS/EVSE system and the users of the exemplary system. In FIG. 2, a user 260 interfaces with an EVCS/EVSE 240 using a display apparatus 250 (e.g., a touchscreen display apparatus). The display apparatus 250 allows the user to view operating instructions and/or to make entries of information. As noted above, the functionality of the display apparatus 250 can be implemented by executing appropriate EVCS/EVSE software stored at the EVCS/EVSE (e.g., EVCS/EVSE software 102). The EVCS/EVSE 240 uses a communication device (e.g., one or more of the wireless radio 104 or Ethernet card 108 shown in FIG. 1) to establish a communication link 230 with a back office server 220. The functionality of the back office server 220 can be implemented by executing appropriate back office software stored at the back office server 220 (e.g., back office server software 124). The EVCS/EVSE 240 also uses the communication device to transmit information entered by the user 260 to the back office server 220. This information can comprise, for example, entries made by the user via the display apparatus 250.

The back office server 220 in FIG. 2 is also configured to operate a website 128 for exchanging information relative to the EVSE/EVSE with the EVCS/EVSE user 260. The information can comprise, for example, the current status of the user's account, account records for the user, or other such information. The user 260 can use this website to increase the credit balance on their account and manage payment sources (i.e. link the account to a bank account or credit/debit card).

In the illustrated embodiment, when a user enters a parking facility, the user will receive a parking stub or ticket 290 that is dispensed by a parking payment kiosk (“PPK”) 270. This PPK communicates with a parking back office 210 using a communications link 230 that can be either wired or wireless. Using the disclosed technology, the user 260 will use the parking stub or ticket 290 to pay for parking and electricity usage at the EVCS/EVSE 240. The parking back office 210 can additionally communicate with the back office server 220 (e.g., using a suitable network connection, such as any of the network connections disclosed above). Furthermore, although the parking back office 210 and the back office server 220 are shown as distinct in FIG. 2, it is to be understood that in some embodiments the functions of the two servers are performed by a single computer or server and operated by a single entity.

FIG. 3 is a flow chart 300 showing an exemplary process for using an EVCS/EVSE to pay for parking and electricity usage using the disclosed technology. As noted above, the functionality shown in FIG. 3 can be implemented by computing hardware executing computer-executable instructions. The various procedures shown in FIG. 3 should not be construed as limiting, as any one or more of the procedures can be performed alone or in various other combinations and subcombinations with one another.

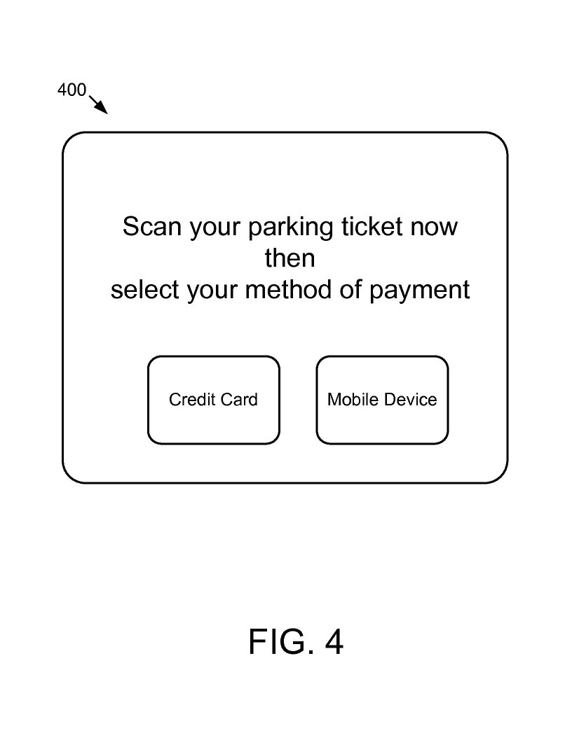

In particular embodiments, the user will enter a parking facility and receive a parking stub or ticket from a PPK (process block 302). The user will then park the vehicle in the area designated for use of the EVCS/EVSE and initiate an EV charging session on the EVCS/EVSE by plugging in their EV and/or interacting with the EVCS/EVSE user interface (process block 304). The EVCS/EVSE will generate a unique charging session identifier to uniquely identify this charging session that has just been initiated. The EVCS/EVSE can then allow the user to indicate that they have a parking stub or ticket and wish to combine the payment for parking and electricity (process block 306). Once the user has made this selection, the user will enter the parking stub or ticket's unique parking session identifier in the EVCS/EVSE (process block 308). This can be done by reading the data encoded in the stub/ticket's magnetic strip with the EVCS/EVSE's magnetic card reader, having the user enter the stub/ticket's identifier using the EVCS/EVSE's display apparatus and/or keypad, scanning the stub/ticket's identifier using a camera or scanner at the EVCS/EVSE, or another suitable method. FIG. 4 shows a representative display screen shown on an EVCS/EVSE display apparatus instructing the user to scan the identifier on their parking ticket/stub.

Variations of this method also allow the user to scan or enter the stub/ticket's parking session identifier using a mobile payment application running on an Internet-connected mobile device. Such embodiments can use any of the techniques described in U.S. Nonprovisional application Ser. No. 14/047,842 filed on Oct. 5, 2013, and entitled “SYSTEM FOR PARKING PAYMENT USING A MOBILE DEVICE”; U.S. Provisional Application No. 61/710,643 filed on Oct. 5, 2012, and entitled “SYSTEM FOR PARKING PAYMENT USING A MOBILE DEVICE”; U.S. Nonprovisional application Ser. No. 14/014,108, filed on Aug. 29, 2013 and entitled “ELECTRIC VEHICLE CHARGING STATION MOBILE DEVICE PAYMENT SYSTEM”; and U.S. Provisional Application No. 61/694,647, filed on Aug. 29, 2012, and entitled “ELECTRIC VEHICLE CHARGING STATION MOBILE DEVICE PAYMENT SYSTEM”, all of which hereby incorporated herein by reference.

In some embodiments, the user can also identify themselves for billing purposes (process block 310). This can be done by reading identity and/or payment data encoded on a magnetic strip of the user's credit card, bank card, or other such account card with the EVCS/EVSE's magnetic card reader, having the user enter identification data via the EVCS/EVSE's display apparatus and/or keypad, scanning a barcode encoding the data (e.g., from a barcode on a credit card or payment card) using the camera or scanner at the EVCS/EVSE, or another suitable method. Once the user has entered this data, the EVCS/EVSE will send a message to the EVCS/EVSE back office server that includes the charging session identifier, the parking session identifier, and/or the user's identification data (process block 312). The user's identification data may comprise one or more of a credit card account number for the user, a bank account number for the user, a debit account number for the user, the name or membership identification number of the user, a vehicle identification number (such as a VIN number or license plate number), or any other suitable identification information that allows the user to be authorized for the combined charging and parking session. In particular embodiments, the message transmitted to the back office server comprises a dataset that includes the charging session identifier, the parking session identifier, and the user's identification data. In effect, this dataset includes sufficient information to link the parking session and the charging session so that they can be paid for through a combined payment (e.g., in a single transaction).

In certain embodiments, the user's identification data is not collected and transmitted with the dataset. Instead, the parking session identifier and the charging session identifier are sent in a dataset without the user's identification data. In these embodiments, this dataset is still sufficient to create a linkage between the two sessions that enables combined payment when the sessions are complete. For example, when the user disconnects his or her electric vehicle from the charging port, the EVCS/EVSE can detect that the charging session is complete and send information to the EVCS/EVSE back office that indicates the charging session identifier along with appropriate information for computing the charging session cost. The charging session identifier can then be used to locate the appropriate dataset along with the associated parking session identifier, thereby facilitating the combined payment for both sessions.

If an Internet-connected mobile device was used to read/enter/scan the stub/ticket's parking session identifier, this mobile device will transmit the dataset comprising the ticket/stub's parking session identifier, the charging session identifier (e.g., scanned from a code displayed on the EVCS/EVSE), and the user's identification data, to the back office. If the appropriate user identification data is not stored by the mobile device, it can be input to the mobile device through user entry on the keypad or touchscreen of the mobile device or via a reader or scanner similar to those described above with respect to the EVCS/EVSE.

Once the EVCS/EVSE back office server receives this data, and in some embodiments in which a separate parking back office server exists, the EVCS/EVSE back office application will transmit the parking ticket/stub's identifier, along with other appropriate data to identify the parking session, to the parking back office server (process block 314). Upon receiving this data, the parking back office server will store it for use in closing out the parking session at a later time (process block 316 and 318).

Returning to the EVCS/EVSE back office, once it receives the data sent by the EVCS/EVSE in process block 312, the EVCS/EVSE back office application stores the charging session identifier, the user identification data, and/or the parking stub/ticket identifier in a database (process blocks 320 and 322). In some embodiments, the EVCS/EVSE back office uses this information to determine whether the user is authorized to initiate a charging session at the EVCS/EVSE. For instance, the user may have a charging station membership account that is identified, or the payment information can be used to check whether the user is authorized to incur account charges (e.g., by accessing the user's bank or credit card issuer). If the user is authorized, this authorization can be transmitted to the EVCS/EVSE and/or to the user's mobile device.

In the illustrated embodiment, once the charging session is authorized and initiated, the EVCS/EVSE continues to deliver an electrical charge to the EV until the charging is complete (e.g., until the user returns to their vehicle and unplugs it) (process blocks 324 and 326). When the charging session is complete, the EVCS/EVSE will compute both the electrical charging costs and the parking costs and prompt the user for payment (process blocks 328 and 330). Note that this computation may involve communication with the EVCS back office server, which may further communicate with the parking back office server. It should be noted that the disclosed technology supports a number of payment methods. The user could swipe a credit or debit card or other such payment card at the EVCS/EVSE magnetic card reader, use a radio frequency identification tag that is tied to an account at the EVCS/EVSE back end, enter payment information via the touchscreen on the display apparatus, select to use payment information associated with the user and stored at the EVCS/EVSE back end, select to debit from an account established with the parking facility, scan a code displayed on the EVCS/EVSE display apparatus with a mobile device payment application, select to use a payment account that was provided during the user authorization process, or use any other suitable payment method. For example, payment can be made using a mobile device payment application that uses any of the features described in U.S. Nonprovisional application Ser. No. 14/047,842 filed on Oct. 5, 2013, and entitled “SYSTEM FOR PARKING PAYMENT USING A MOBILE DEVICE” or U.S. Provisional Application No. 61/694,647, “ELECTRIC VEHICLE CHARGING STATION MOBILE DEVICE PAYMENT SYSTEM”, both of which are hereby incorporated herein by reference.

Once the user enters their payment information, the EVCS/EVSE will transmit the charging session identification and the user's payment data to the EVCS/EVSE back office server for processing (process block 332). If a mobile device payment application is used, the mobile device payment application will transmit the charging session identification and user's payment information to the EVCS/EVSE back end instead of the data arriving at the EVCS/EVSE back end from the EVCS/EVSE.

Once the EVCS/EVSE back office receives the user's payment information, the EVCS/EVSE back office will process this payment (process block 334). Once the payment has been processed, the EVCS/EVSE back office will store this transaction in the EVCS/EVSE database, and transmit the payment approval to the EVCS/EVSE (process blocks 336 and 322). If the user is using a mobile payment application on an Internet-connected mobile device, the EVCS/EVSE back office will also transmit the transaction approval to this mobile payment application.

In addition to sending the payment approval to the EVSE, and in the illustrated embodiment, the EVCS/EVSE back office will also transmit the parking ticket/stub identifier and the payment processing approval to a parking back office system (process block 338). This action may be done using a cloud-based service, using an Internet connection, using any other network connection disclosed herein, or other suitable methods. In some instances, and as noted above, the parking back office server may be coincident with the EVCS/EVSE back office (e.g., a common back office environment).

Once the parking back office server receives the payment approval, it will store this information in a parking database (process blocks 340 and 318). The parking back office will also transmit the parking stub/ticket identifier and payment approval to an exit control station (process block 342). When the user presents the parking stub/ticket at the exit control station (process block 344), the exit control station will recognize that the user has paid for the parking services and allow the user to exit the parking facility (process block 346).

### III. Further Embodiments

Having described and illustrated the principles of the disclosed technology in the detailed description and accompanying drawings, it will be recognized that the various embodiments can be modified in arrangement and detail without departing from such principles. Furthermore, any features or aspects of the disclosed embodiments can be used in various combinations and subcombinations with one another.

Furthermore, it is to be understood that any of the features and embodiments described herein can be used in combination with any of the features and embodiments described in U.S. Nonprovisional application Ser. No. 14/047,842 filed on Oct. 5, 2013, and entitled “SYSTEM FOR PARKING PAYMENT USING A MOBILE DEVICE”; U.S. Provisional Application No. 61/710,643 filed on Oct. 5, 2012, and entitled “SYSTEM FOR PARKING PAYMENT USING A MOBILE DEVICE”; U.S. Nonprovisional application Ser. No. 14/014,108, filed on Aug. 29, 2013 and entitled “ELECTRIC VEHICLE CHARGING STATION MOBILE DEVICE PAYMENT SYSTEM”; U.S. Provisional Application No. 61/694,647, filed on Aug. 29, 2012, and entitled “ELECTRIC VEHICLE CHARGING STATION MOBILE DEVICE PAYMENT SYSTEM”; and U.S. Provisional application Ser. No. 71/728,134, filed on Nov. 19, 2012, and entitled “RESERVATION SYSTEMS FOR ELECTRIC VEHICLE CHARGING STATIONS”, all of which hereby incorporated herein by reference.

Furthermore, it is to be understood that any of the features and embodiments described herein can be used in combination with any of the features and embodiments described in U.S. Provisional Application No. 61/307,318, filed on Feb. 23, 2010, and entitled “ELECTRIC VEHICLE CHARGING STATION WITH TOUCH SCREEN USER INTERFACE”; U.S. Provisional Application No. 61/409,108, filed on Nov. 1, 2010, and entitled “ELECTRIC VEHICLE CHARGING STATION WITH TOUCH SCREEN USER INTERFACE”; U.S. Provisional Application No. 61/307,377, filed on Feb. 23, 2010, and entitled “ELECTRIC VEHICLE CHARGING STATION ADVERTISING SYSTEM”; U.S. Provisional Application No. 61/353,944, filed on Jun. 11, 2010, and entitled “ELECTRIC VEHICLE CHARGING STATION ADVERTISING SYSTEM”; U.S. Provisional Application No. 61/317,181, filed on Mar. 24, 2010, and entitled “ELECTRIC VEHICLE CHARGING STATION PARKING METER SYSTEM”; U.S. Nonprovisional application Ser. No. 12/954,209, filed on Nov. 24, 2010, and entitled “ELECTRIC VEHICLE CHARGING STATION ADVERTISING SYSTEMS” (published as U.S. Patent Application Publication No. 2011/0204847), U.S. Nonprovisional application Ser. No. 13/033,179, filed on Feb. 23, 2011, and entitled “ELECTRIC VEHICLE CHARGING STATIONS WITH TOUCH SCREEN USER INTERFACE” (published as U.S. Patent Application Publication No. 2011/0213656), and U.S. Nonprovisional application Ser. No. 13/070,389, filed on Mar. 23, 2011, and entitled “ELECTRIC VEHICLE CHARGING STATION PARKING METER SYSTEMS” (published as U.S. Patent Application Publication No. 20110239116), all of which are hereby incorporated herein by reference.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. I therefore claim as my invention all that comes within the scope and spirit of these claims and their equivalents.

What is claimed is:

1. A method of combining payment for a charging session at an electric vehicle charging station (“EVCS”) or electric vehicle supply equipment (“EVSE”) with payment for parking services, comprising:
by computing hardware,
obtaining a parking session identifier from a unique identifier printed on a parking stub or ticket that is issued to a user upon entry into a parking facility; and
combining the parking session identifier with a charging session identifier generated by the EVSE/EVCS to form a dataset that can be used to process a combined payment for both the charging session and the parking session; and
transmitting the dataset to a back-end EVSE/EVCS server.

2. The method of claim 1, further comprising:
processing the combined payment for both the charging session and the parking once the total cost of the charging session and the parking session are known; and
transmitting the results of the combined payment processing to an exit control device to allow the user to exit the parking facility.

3. The method of claim 1, wherein the unique identifier of the parking stub or ticket is read or scanned by a camera, magnetic card reader, or barcode reader integrated into the EVCS/EVSE or integrated into an Internet-connected mobile device associated with the user.

4. The method of claim 1, wherein the combining the parking session identifier with the charging session identifier is performed by a software application running on the EVCS/EVSE.

5. The method of claim 1, wherein the combining the parking session identifier with the charging session identifier is performed by a software application on an Internet-connected mobile device.

6. The method of claim 5, wherein the charging session identifier is obtained by scanning a barcode or alpha-numeric code displayed on the EVCS or EVSE and the parking session identifier is obtained by scanning the unique identifier printed on a parking stub or ticket.

7. The method of claim 6, wherein the combining further comprises including user identification data in the dataset, and wherein the method further comprises receiving a response from the back-end EVCS/EVSE server indicating whether the user is authorized to use the EVCS or EVSE.

8. The method of claim 1, further comprising:
receiving a message from a remote computer indicating that the user has properly paid for the charging session and the parking at the parking facility; and
allowing the user to exit the parking facility.

9. The method of claim 1, wherein the combining further comprises including user identification data in the dataset.

10. A method of combining payment for a charging session at an electric vehicle charging station (“EVCS”) or electric vehicle supply equipment (“EVSE”) with payment for parking services, comprising:
by computing hardware,
receiving a selection by a user to combine payment for the charging session with payment for a parking session; and
combining a parking session identifier with user identification data and a charging session identifier that is generated by the EVSE/EVCS to form a dataset that can be used to process a combined payment for both the charging session and the parking session.

11. One or more non-transitory computer-readable media storing computer-executable instructions which when executed by a processor cause the processor to perform a method of combining payment for a charging session at an electric vehicle charging station (“EVCS”) or electric vehicle supply equipment (“EVSE”) with payment for a parking session, the method comprising:
obtaining a parking session identifier from a unique identifier of a parking stub or ticket that is issued to a user upon entry into a parking facility; and
combining the parking session identifier with a charging session identifier generated by the EVSE/EVCS to form a dataset that can be used to process a combined payment for both the charging session and the parking session.

12. The one or more non-transitory computer-readable media of claim 11, wherein the unique identifier of the parking stub or ticket is read or scanned by a camera, magnetic card reader, or barcode reader integrated into the EVCS/EVSE or integrated into an Internet-connected mobile device associated with the user.

13. The one or more non-transitory computer-readable media of claim 11, wherein the combining the parking session identifier with the charging session identifier is performed by a software application running on the EVCS/EVSE.

14. The one or more non-transitory computer-readable media of claim 11, wherein the combining the parking session identifier with the charging session identifier is performed by a software application on an Internet-connected mobile device.

15. The one or more non-transitory computer-readable media of claim 14, wherein the charging session identifier is obtained by scanning a barcode or alpha-numeric code displayed on the EVCS or EVSE.

16. The one or more non-transitory computer-readable media of claim 15, wherein the combining further comprises including user identification data in the dataset; and wherein the method further comprises:
transmitting the dataset to a back-end server via wired or wireless communication; and
receiving a response from the back-end server indicating whether the user is authorized to use the EVCS or EVSE.

17. The one or more non-transitory computer-readable media of claim 11, wherein the method further comprises receiving a message from a back-end server indicating that the user has properly paid for the charging session and the parking at the parking facility.

18. The one or more non-transitory computer-readable media of claim 11, wherein the combining further comprises including user identification data in the dataset.

19. One or more non-transitory computer-readable media storing computer-executable instructions which when executed by a processor cause the processor to perform a method of combining payment for a charging session at an electric vehicle charging station (“EVCS”) or electric vehicle supply equipment (“EVSE”) with payment for a parking session, the method comprising:
receiving a selection by a user to combine payment for the charging session with payment for a parking session; and
combining a parking session identifier with user identification data and a charging session identifier that is generated by the EVSE/EVCS to form a dataset that can be used to process a combined payment for both the charging session and the parking session.

20. An electric vehicle charging station (“EVCS”) or electric vehicle supply equipment (“EVSE”), comprising:
one or more charging ports configured to be coupled to an electric vehicle and to charge one or more batteries of the electric vehicle;
a display device;
a magnetic strip reader, camera, or barcode scanner;
a network communication device;
a computer processor, the computer processor being programmed to:
cause a unique charging session code to be generated;
cause a user interface screen to be displayed on the display device, the user interface screen (a) prompting the user to input, read, image, or scan a unique parking session identifier, and (b) prompting the user to input, read, image, or scan payment information,
receive the unique parking session identifier and the payment information from one or more of a touchscreen interface associated with the display apparatus, the magnetic strip reader, the camera, or the barcode scanner, and
transmit the unique charging session code, the unique parking session identifier, and the payment information to a remote server using the network communication device.

21. The EVCS or EVSE of claim 20, wherein the processor is further programmed to receive a response from the remote server, the response indicating whether the user is authorized for charging and parking.

22. The EVCS or EVSE of claim 20, wherein the network communication device comprises one of a wireless radio, a cellular radio, a Wi-Fi radio, or a LAN connection.

23. The EVCS or EVSE of claim 20, wherein the EVCS or EVSE further comprises a radio frequency identification (“RFID”) reader, and wherein the payment information can additionally be received from the RFID reader.

24. A parking facility exit control device, wherein the parking facility exit control device comprises:
a network communication device; and
computing hardware configured to:
receive a message from a remote server via the network communication device, the message indicating that payment by a user for charging and parking was properly authorized, and
allow the user to exit the parking facility.
